(19) United States
(12) Patent Application Publication
(10) Pub. No.: US 2022/0182253 A1
(43) Pub. Date: Jun. 9, 2022

(54) SUPPORTING A MEETING

(71) Applicant: Hewlett-Packard Development Company, L.P., Spring, TX (US)

(72) Inventors: Abhijeet Dattatraya Pawar, Pune (IN); MANOHAR LAL KALWANI, Pune (IN); Sandip Brahmachary, Pune (IN)

(21) Appl. No.: 17/544,764

(22) Filed: Dec. 7, 2021

(30) Foreign Application Priority Data
Dec. 8, 2020 (IN) 202041053360

(51) Int. Cl. H04L 12/18; G10L 15/18; G10L 15/26

(52) U.S. Cl. CPC H04L 12/1831; H04L 12/1818; G10L 15/26; G10L 15/18; H04L 12/1827

(57) ABSTRACT

A method of electronically supporting a meeting includes, with a computerized agent having a mailbox, receiving a meeting invite from a meeting organizer, the meeting invite including meeting participants, meeting attendance information and a meeting agenda; and with the agent, in response to receiving the meeting invite, automatically communicating with the meeting participants in advance of the meeting to prepare for the meeting. The agent may answer questions during the meeting. A computerized agent includes a bot for supporting a meeting using artificial intelligence to process an electronic recording of the meeting to extract information about the meeting for a meeting organizer or participant. The hot is deployed as a docker containerized service. A non-transitory computer-readable medium includes a computerized agent for supporting a planned meeting, the agent comprising: instructions for receiving meeting information about the planned meeting, including meeting participants and a meeting agenda; and instructions for, in response to receiving the meeting information, communicating electronically with the meeting participants to request information related to the meeting agenda.

### BACKGROUND

Meetings to coordinate activities, report progress, make decisions and/or make assignments are ubiquitous in virtually all organizations. Different members of an organization will have information from their respective areas of responsibility that can be shared with other members in a meeting so that other parts of the organization, represented by other meeting attendees, can utilize that information. However, the various attendees at a meeting may not remember all the information that was shared, decisions taken or assignments made. Consequently, a meeting attendee may want to make notes of the meeting. However, this may distract the attendee who, while noting something, misses some other important comment in the meeting.

### BRIEF DESCRIPTION OF THE DRAWINGS

The accompanying drawings illustrate various implementations of the principles described herein and are a part of the specification. The illustrated implementations are merely examples and do not limit the scope of the claims.

FIG. 1 is a flowchart illustrating an example of a method of electronically supporting a meeting using an automated agent consistent with the disclosed implementations.

FIG. 2 is a further flowchart illustrating more detail of the method of FIG. 1, consistent with the disclosed implementations.

FIG. 3 is a further flowchart illustrating more detail of the method of FIG. 1, consistent with the disclosed implementations.

FIG. 4 is a diagram of a computerized agent, consistent with the disclosed implementations.

FIG. 5 is a diagram of a computerized agent, consistent with the disclosed implementations.

FIG. 6 is a diagram of a non-transient, computer-readable storage medium containing an agent, consistent with the disclosed implementations.

FIG. 7 is a diagram of a non-transient, computer-readable storage medium containing an agent, consistent with the disclosed implementations.

FIG. 8 is a flowchart illustrating an example of a method of electronically supporting a meeting using an automated agent consistent with the disclosed implementations.

FIG. 9 is a flowchart illustrating an example of a method of electronically supporting a meeting using an automated agent consistent with the disclosed implementations.

FIG. 10 is a flowchart illustrating an example of a method of electronically supporting a meeting using an automated agent consistent with the disclosed implementations.

FIG. 11 is an example of items in minutes of meeting prepared by the bot and sources of the items, consistent with the disclosed implementations.

FIG. 12 is a flowchart illustrating an example of a method of electronically supporting a meeting using an automated agent consistent with the disclosed implementations.

FIG. 13 is a flowchart illustrating an example of a method of electronically supporting a meeting using an automated agent consistent with the disclosed implementations.

FIG. 14 is a flowchart illustrating an example of a method of electronically supporting a meeting using an automated agent consistent with the disclosed implementations.

FIG. 15 is a diagram of a computing device for supporting a meeting, consistent with the disclosed implementations.

FIG. 16 is a flowchart illustrating an example of a method of electronically supporting a meeting using an automated agent consistent with the disclosed implementations. Throughout the drawings, identical reference numbers designate similar, but not necessarily identical, elements.

### DETAILED DESCRIPTION

As noted above, meetings to coordinate activities, report progress, make decisions and/or make assignments are ubiquitous in virtually all organizations. Recently, meetings between a number of participants have been supported by electronic platforms, including conference calling, video conferencing and internet-based meeting applications with both video and audio.

However, as noted above, the various attendees at a meeting may not remember all the information that was shared, decisions taken or assignments made. Consequently, tools that record or track the content of a meeting may be helpful for an attendee. With meeting occurring on electronic platforms, the ability to implement computerized tools to support the meeting has increased. Consequently, automated tools have been developed that may help users to organize, capture content from, and report on a meeting.

Most recently, artificial intelligence has been introduced into an electronic meeting context to perform various tasks before, during, and/or after electronic meetings. The tasks may include a wide variety of tasks, such as agenda creation, participant selection, real-time meeting management, meeting content supplementation, and post-meeting processing.

The present specification describes new tools, methods and systems for supporting a meeting, particularly a meeting using an electronic platform. In various examples, the present specification describes the following.

In one example, the present specification describes a method of electronically supporting a meeting, the method including: with a computerized agent having a mailbox, receiving a meeting invite from a meeting organizer, the meeting invite including meeting participants, meeting attendance information and a meeting agenda; and with the agent, in response to receiving the meeting invite, automatically communicating with the meeting participants in advance of the meeting to prepare for the meeting. Examples of this method may include, in advance of the meeting, operating the agent for: communicating electronically with meeting participants to request information relevant to the meeting agenda; and transmitting to the meeting participants background information for items on the meeting agenda. Examples of this method may include, during the meeting, operating the agent for: recording audio of the meeting and processing the audio of the meeting to produce a record of the meeting and using speech-to-text conversion on the recorded audio of the meeting and Natural Language Processing (NLP) to produce a meeting summary. The summary may include, for example, issues raised; suggestions made; and action items assigned. The method may also include, with the agent, preparing an attendance record of the meeting based on participant login and voice recognition; and providing the attendance record to the meeting organizer.

In another example, the present specification describes a computerized agent that includes a bot for supporting a meeting using artificial intelligence to process an electronic recording of the meeting to extract information about the meeting for a meeting organizer or participant. The bot may be deployed as a docker containerized service, with Kubernetes as a container orchestration engine for the docker containerized service of the bot. An electronic conference client can be bundled with a container image of the bot. This illustrative agent may also include a bot scheduler deployed as a container, the bot scheduler to initialize a separate container for each meeting.

The illustrative agent may also have an inbox in which to receive a meeting invite with information for a meeting, including meeting participants. The bot can then respond to receipt of the meeting invite by automatically communicating with the meeting participants in advance of the meeting to prepare for the meeting.

In another example, the present specification describes a non-transitory computer-readable medium comprising a computerized agent for supporting a planned meeting, the agent including: instructions for receiving meeting information about the planned meeting, including meeting participants and a meeting agenda; and instructions for, in response to receiving the meeting information, communicating electronically with the meeting participants to request information related to the meeting agenda. The agent may also include instructions for identifying information in a knowledgebase that is related to the meeting agenda; and transmitting the identified information to the meeting participants in advance of the meeting.

As used herein, the term “artificial intelligence,” or AI, will refer to the ability of a computer system, appropriately programmed, to reason, discover meaning, generalize, or learn from past experience. AI systems have been developed and applied in a wide variety of fields where a training set of data is provided to the AI system which, when processed, allows the AI system to make decisions or predictions using data similar to what was included in the training set. This may also be referred to as machine learning.

As used herein, “Natural Language Processing” (NLP) refers to a form of artificial intelligence in which a computer or computer system is programmed to process textual input as it would be spoken or written by a human being, recognize the words and parts of speech included and the relationship between the parts of speech so as to produce an electronic understanding of the textual input that allows for valuable processing of the textual input. For example, NLP may process textual input from a meeting to identify issues raised, suggestions made or action items assigned and to whom.

As used herein, “voice recognition” refers to the technique of analyzing a sample of a user's voice to distinguish the identity of the user as among other users. Voice recognition may also refer to speech-to-text functions that produce electronic text from capturing a user's spoken words.

As used herein, the term “computerized agent” or simply “agent” refers to an entity in a computerized environment that is supported with specific programming, processing and memory resources to perform specified functionality. An agent may include artificial intelligence that is used in performing the specified functionality of the agent. For example, as described herein, an agent may be equipped to support a meeting between a number of human attendees by performing a variety of functions such as scheduling or preparing for the meeting, capturing data from the meeting that is organized into a form that suits the needs of the attendees and providing follow up for attendees after the meeting.

As used herein, the term “bot” refers to a software application that runs automated tasks in a computer environment, for example, over the Internet. A bot or a number of bots may be included in an agent to support the functionality of the agent.

As used herein, the term “container” refers to a logical packaging mechanism in which applications can be abstracted from the environment in which they actually run. This decoupling allows container-based applications to be deployed easily and consistently, regardless of whether the target environment is a private data center, the public cloud, or even a developer's personal laptop. Containers are isolated from one another and bundle their own software, libraries and configuration files. Containers can communicate with each other through well-defined channels. All containers in a system may be run by a single operating system kernel. In more specific examples, the container includes an entire runtime environment: an application, all its dependencies, libraries, other binaries, and configuration files needed to run it, bundled into one package.

As used herein, the term “containerized service” refers to a service provided using containers.

As used herein, the term “container orchestration engine” refers to an engine that automates the deployment, management, scaling, and networking of containers. Kubernetes is an example of a container orchestration engine. Kubernetes (K8s) is an open-source system for automating deployment, scaling, and management of containerized applications. The Kublet is the primary “node agent” that runs on each node. A K-proxy is a network proxy that runs on each node in cluster. Etcd is the primary datastore of Kubernetes; storing and replicating Kubernetes cluster state. A Kubernetes pod is a group of containers.

As used herein, “docker” refers to a set of platform-as-a-service (PaaS) products that use Operating System (OS)-level virtualization to deliver software in containers.

As used herein, the term “mailbox” or “inbox” refers to a portion of an email client that receives email messages addressed to a particular user or entity, such as a computerized agent.

As used herein, the term “electronic conference client” refers to an application that supports an electronic conference or meeting between attendees.

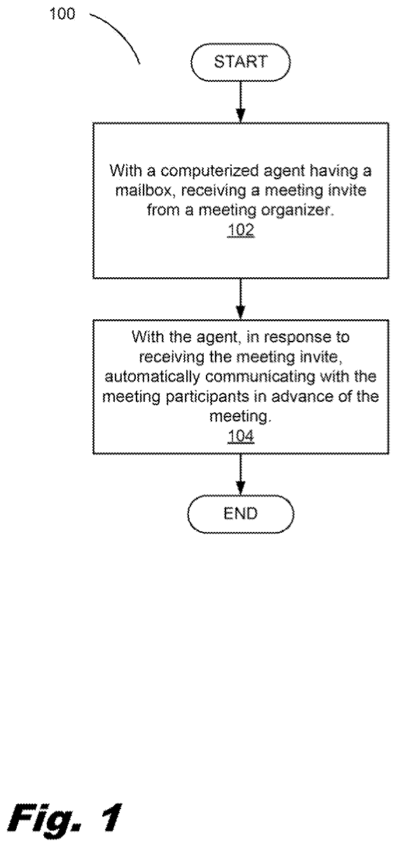

FIG. 1 is a flowchart illustrating an example of a method of electronically supporting a meeting using an automated agent consistent with the disclosed implementations. As shown in FIG. 1, a method of electronically supporting a meeting includes, with a computerized agent having a mailbox, receiving a meeting invite 102 from a meeting organizer, the meeting invite including meeting participants, meeting attendance information and a meeting agenda; and, with the agent, in response to receiving the meeting invite, automatically communicating 104 with the meeting participants in advance of the meeting to prepare for the meeting.

As described herein, a computerized agent is used to support a meeting, particularly a meeting in an electronic context. For example, the meeting may be conducted via an electronic conference client, such as Zoom® by Zoom Video Communications, Inc. or Teams or Skype by Microsoft® Inc. In an electronic context, the agent may interface with the electronic conference client as a participant, like any other attendee. Using a participant's or other interface, the agent can capture all the electronic content of the meeting, video and audio. Using artificial intelligence, including Natural Language Processing, the agent can recognize and record aspects of the meeting such as issues raised, suggestions made and assignments made. A record of the meeting, including this and possibly other items, can be prepared and provided to the meeting organizer and, as desired, the meeting attendees.

Meetings, particularly those conducted via an electronic conference client, are often scheduled or organized using email. The organizer will send an email to the invited attendees to alert them to the meeting. This email may include the date and time of the meeting, a link or other credentials for connecting to the meeting using a designated electronic conference client, meeting agenda details, identification of the people invited to attend, and a request that each invited person confirm their attendance.

In the method of FIG. 1, the computerized agent that will support the meeting has a mailbox or inbox and is included on the meeting invite email produced by the meeting organizer. This will provide the agent with all the information available in the meeting invite including meeting participants, meeting attendance information and a meeting agenda. The meeting agenda may simply be a name for the meeting that suggests the purpose of the meeting or a single statement of the purpose of the meeting. Alternatively, the meeting agenda may be much more detailed, for example, including a list of topics to be addressed at the meeting.

Thus, the method in FIG. 1 may begin with a computerized agent having a mailbox, receiving 102 a meeting invite from a meeting organizer, the meeting invite including meeting participants, meeting attendance information and a meeting agenda. Then, in response to receiving the meeting invite, the agent will automatically communicate 104 with the meeting participants in advance of the meeting to prepare for the meeting.

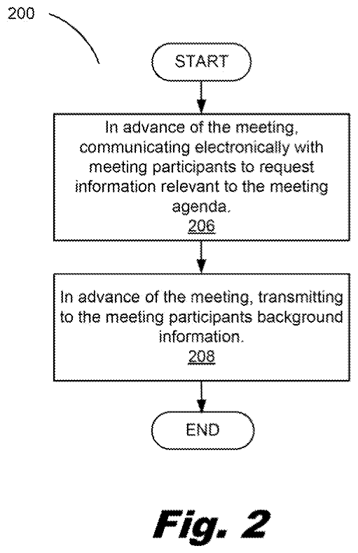

FIG. 2 is a further flowchart illustrating more detail of the method of FIG. 1, consistent with the disclosed implementations. Specifically, FIG. 2 illustrates some of the possibilities for the agent's communication with meeting participants in advance of the meeting.

As shown in FIG. 2, the method 200 may include, with the agent electronically requesting information relevant to the meeting agent 206 from the designated participants in advance of the meeting. With the meeting invite email, the agent will have an email address or perhaps other contact information for the requested participants and the meeting agenda. Consequently, the agent can formulate and send requests to the participants for information they have relevant to the meeting agenda.

In some cases, if may assist the other participants to see such information prior to the meeting. Accordingly, the agent may, upon receipt of the requested information from the meeting participants, distribute that information as background for the meeting to the other participants.

The agent may also use the meeting agenda to develop other background information for participants of the meeting. For example, if the meeting agenda indicates that a particular project will be discussed, the agent may access an organization database or knowledgebase for the latest information about that project. This information or links into the knowledgebase may be helpful for the meeting participants to receive in advance of the meeting.

Thus, the agent may acquire information relevant to the meeting agenda by requesting it from meeting participants or searching organization-based or other knowledgebases. In all cases, the collected background information can then be transmitted 208 to the meeting participants in advance of the meeting to help make the meeting be more efficient and productive.

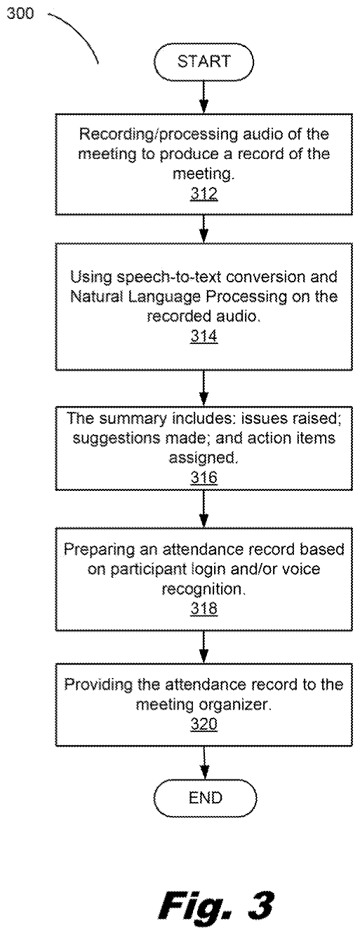

FIG. 3 is a further flowchart illustrating more detail of the method of FIG. 1, consistent with the disclosed implementations. FIG. 3 illustrates elements of the method that the agent may perform during a scheduled meeting.

As shown in FIG. 3, the method 300 may include, with the agent, recording audio of the meeting 312 and processing the audio of the meeting to produce a record of the meeting. As indicated, this could be performed with the agent connected as a participant, like any other participant, in the electronic conference client hosting the meeting. Alternatively, the agent could receive audio from a microphone positioned in a room hosting an in-person meeting.

In one example, the agent can simply product an audio recording of the meeting as a record of what was said. Alternatively, the agent may process the audio, including in some examples with artificial intelligence, to produce a variety of outputs that capture information from or about the meeting.

For example, the agent may use speech-to-text conversion 314 on the recorded audio of the meeting and Natural Language Processing to produce a meeting summary. The speech-to-text conversion simply converts the captured audio signal of the meeting into computer-processible text. This may produce a written transcript of the meeting. Additionally, the text can be processed with NLP 314.

As described above, NLP allows the agent to identify desired information from the text of the meeting. NLP allows the agent/computer to identify parts of speech and their relationship grammatically and syntactically. This allows the agent to identify, for example, issues raised, suggestions made and/or action items assigned. Any of these can then be compiled into a written meeting summary 316 to be output by the agent.

In other examples, the agent may prepare an attendance record 318 of which participants attended the meeting. This may be done by the agent noting which participants are logged into the meeting, if an electronic conference client is used. This may be done by looking at screen names used in the electronic conference client or looking at login credentials for the electronic conference client.

Alternatively, the agent may use voice recognition 318 to identify participants and compile an attendance record. In this case, samples of different speakers in the audio recording of the meeting are compared with recordings of spoken samples of the invited participants to determine an identity of each of the recorded speakers in the meeting. The speaker identification may be recorded for each time period so that the speech to text conversion of the meeting recording may include the identity of each speaker.

In any event, the agent can then provide the attendance record 320 to the meeting organizer or any other interested party. In some examples, the attendance record is part of minutes of the meeting provided to the interested party.

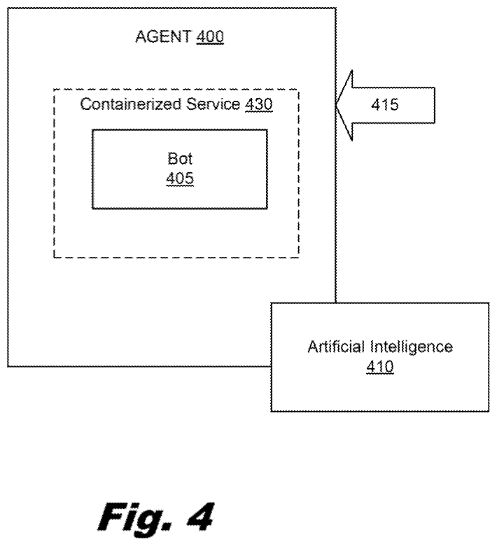

FIG. 4 is a diagram of a computerized agent, consistent with the disclosed implementations. As shown in FIG. 4, the computerized agent 400 includes a bot 405 for supporting a meeting using artificial intelligence 410 to process an electronic recording 415 of the meeting to extract information about the meeting for a meeting organizer or participant. In some examples, the bot 405 is deployed as a docker containerized service 430.

As shown in FIG. 4, the agent 400 may incorporate or may have network access to the artificial intelligence system that performs the AI functionality described herein. For example, the AI 410 may include a Natural Language Processor as described herein.

The electronic recording 415 of the meeting is received by the agent 400. The agent 400 may make the electronic recording 415 by capturing audio from the meeting or may receive a recording of the meeting made by another system. In either case, the audio recording 415 can be processed by the bot 405, for example, using the artificial intelligence 410 to extract information about the meeting that is then provided to a meeting organizer or participant. The extracted information may include problem identification, solutions identified and action items assigned during the meeting. The extracted information may be identified by keywords in sentences during the extraction process.

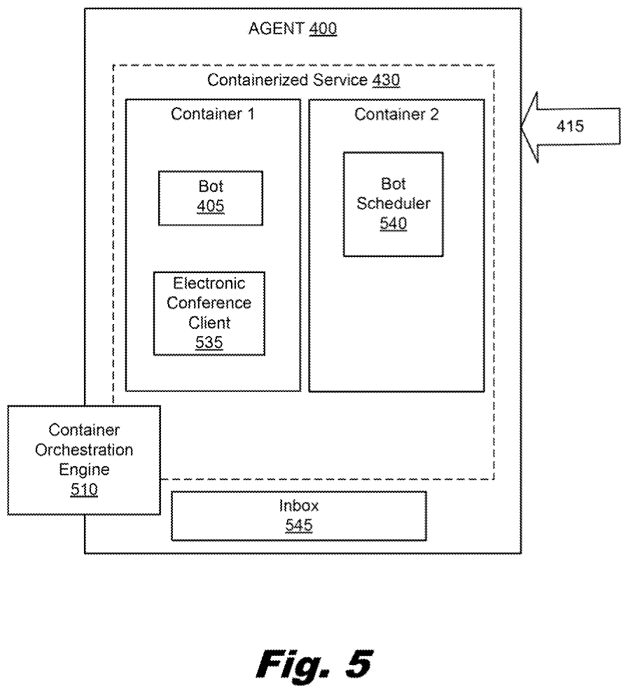

FIG. 5 is a diagram of a computerized agent, consistent with the disclosed implementations. As shown in FIG. 5, the agent 400 utilizes a containerized service 430. The containerized service 400 has a container orchestration engine 510. In some examples, this engine 510 is Kubernetes. In some examples, an electronic conference client 535 is bundled with a container image of the bot 405.

As also shown in FIG. 5, the agent also includes a bot scheduler 540 deployed as a container. The bot scheduler 540 will initialize a separate container for each meeting to be supported by the agent 400.

Also, as described herein, the agent 400 may have an inbox 545. This is an inbox of an email client that allows the agent 400 to be addressed and to receive email as input. As described above, this allows the agent 400 to be included in receiving an email invite for a meeting to be supported by the agent 400. The agent 400 may automatically support the meeting, as described herein, in response to an email invite or other email message with information about the meeting to be supported. Where the email received is a meeting invite, the meeting invite may include the information for the meeting, including meeting participants. The bot responds to receipt of the meeting invite by automatically communicating with the meeting participants in advance of the meeting to prepare for the meeting.

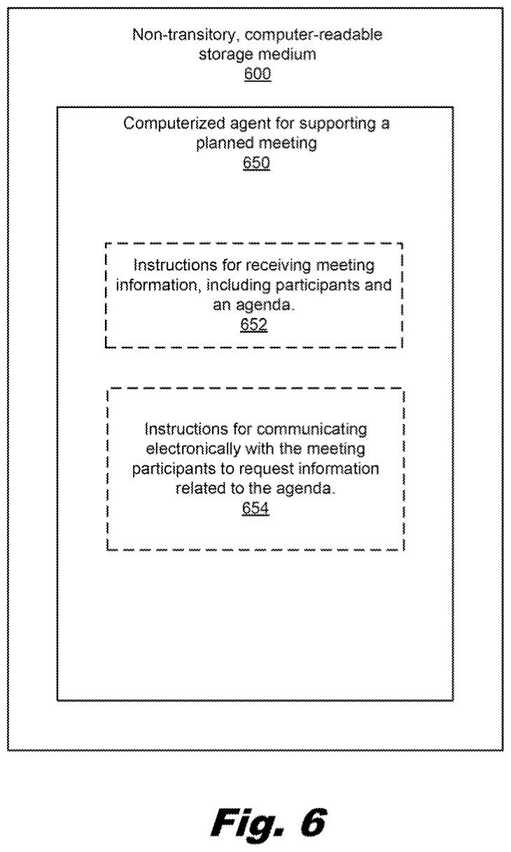

FIG. 6 is a diagram of a non-transient, computer-readable storage medium containing an agent, consistent with the disclosed implementations. As shown in FIG. 6, a non-transitory computer-readable medium 600 supports a computerized agent 650, as described herein, for supporting a planned meeting. The agent 650 includes: instructions 652 for receiving meeting information about the planned meeting, including meeting participants and a meeting agenda; and instructions 654 for, in response to receiving the meeting information, communicating electronically with the meeting participants to request information related to the meeting agenda.

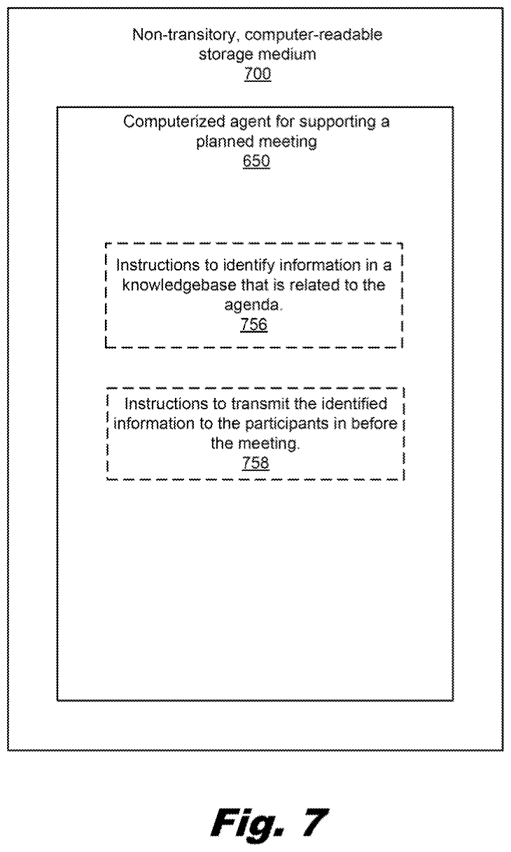

FIG. 7 is a further diagram of the non-transient, computer-readable storage medium 600 containing the agent, consistent with the disclosed implementations. As shown in FIG. 7, in some examples, the agent 650 may include instructions for identifying information 756 in a knowledgebase that is related to the meeting agenda; and transmitting 758 the identified information to the meeting participants in advance of the meeting.

As noted above, more and more collaborations are needed among the internal/external stakeholders across organizations and industries. Consequently, people connect within and outside organizations through virtual meetings, video conferencing & in person meetings. For better productivity in these meetings, each meeting needs to be documented (for example, by transcription) and the outcomes of the meeting should be agreed upon by concerned stakeholders.

The notes or written record of a meeting are often referred to as the minutes of the meeting (MoM). These minutes frequently include the list of attendees, absentees, issues raised, action items, related responses, and final decisions taken to address the issues. The purpose is often to record what actions have been assigned to whom, along with the deadlines.

This MoM creation process may be done manually. However, such records may be incomplete, or some meetings may not be documented at all. This is because preparing MoM adds an additional burden on the meeting organizer and/or participants. Without documentation, many useful items from a meeting may never be implemented.

As noted herein, a MoM agent or bot can be implemented so that each and every meeting can be digitized and documented. Conceptually, the proposed solution is divided in three phases.

Phase 1 (Pre-meeting): Organizer sends the meeting invite to the participants and the AI-enabled MoM bot. Upon receipt of the invite, the bot can take care of task tracking and pre-meeting follow-up. A pre-defined subject knowledgebase (e.g., from a wiki or data class definitions) can be assembled based on the meeting agenda and pre-processed by MoM bot. Some information may be provided in advance to participants.

Phase 2 (In-meeting): Meeting participants and the AI-enabled MoM assistant bot join the meeting as regular participants. The bot may perform real-time Q&A as configured per the knowledgebase collected in Phase 1 and will record the time slots of each speaker's speech for speaker identification. The bot will also record the whole meeting in audio (e.g., mp3, mp4, wmv, etc.) to process in Phase 3.

Phase 3 (Post-meeting): The meeting recording will be first converted from audio to text and will be analyzed/matched with speaker time slots to identify and tag to the appropriate speaker using machine learning and NLP. In some examples, the text, or a portion of the text, is translated to a second language. Further, the MoM will be generated automatically with extractive summarization using the NLP technique. The bot can also interact with other enterprise software such as Jira® or Microsoft® Azure DevOps (ADO), and perform appropriate actions. The draft MoM can be sent to the organizer when completed.

With this solution, a majority of MoM creation tasks are automated. Per meeting, it is estimated that the agent described herein can save 15 to 30 minutes of time across participants in a meeting. The aggregated productivity and time saving across an organization can be significant.

With the described agent/bot having Artificial Intelligence, Natural Language Processing, Machine learning, Language Translator and knowledge repository enabled, many meeting support tasks can be automated without manual intervention. The agent may answer questions during the meeting about the knowledge base assembled and digested prior to the meeting.

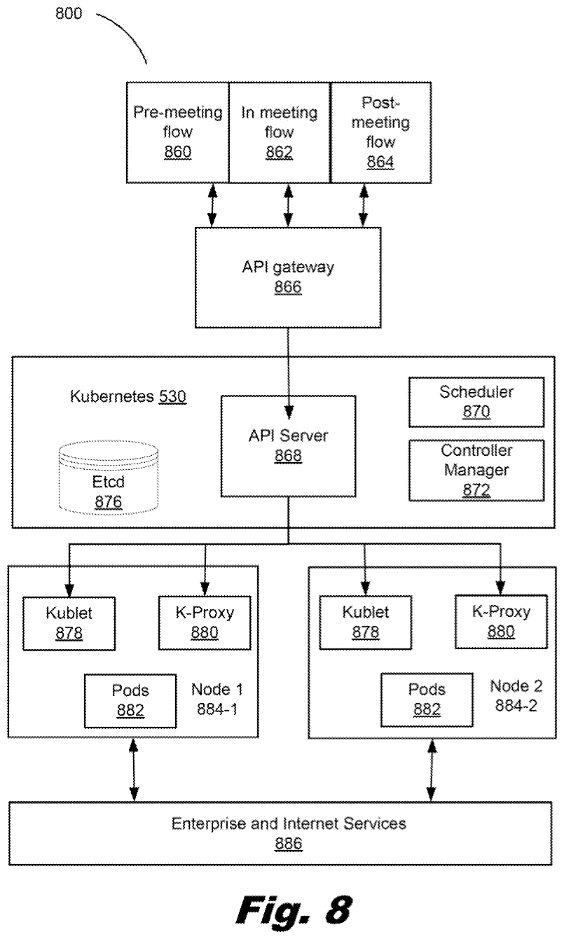

FIG. 8 is a flowchart 800 illustrating an example of a method of electronically supporting a meeting using an automated agent consistent with the disclosed implementations. As shown in FIG. 8, the agent may include three flows, a pre-meeting flow 860, an in-meeting flow 862 and a post-meeting flow 864. These flows of the agent may communicate through an Application Programming Interface (API) gateway 866 with other system components.

As described above, the bot and other related enterprise services can be deployed as docker containerized services. In this environment, a container orchestration engine, e.g., Kubernetes 530, is used and includes an API server 868, a database 876, a scheduler 870 and a controller manager 872.

This orchestration engine 530 may implement a number of nodes, e.g., 884-1 and 884-2. Each node includes a kublet 878, a K-proxy 880 and a number of pods 882. These nodes interact with enterprise and internet services 886, such as email, an authentication/authorization service, the API of a conference tool or client, JIRA/ADO, an enterprise Wiki, a knowledgebase or knowledge repository solution such as Knowledge Repo, Natural Language Processing, an MoM generator, a transcription service, a translation service and storage. The AI bot and enterprise service containers can be stored in a container repository.

The containerized MoM bots and services will be highly available and scalable. The bot scheduler 870 can be deployed as a container and will access the bot calendar at predefined intervals. Consequently, before the scheduled meeting a container for that meeting will be initialized. As noted above, for each meeting, a separate container will be initialized prior to the meeting and a bot process will be created. The bot process/demon will use an underlying conference tool client, which may be pre-bundled with container itself, to join the meeting. The same container will perform in-meeting and post-meeting tasks.

After post-meeting processing, the bot container will auto-terminate itself. The other enterprise services like authentication/authorization, pre-meeting invite processor, conference tool API, ADO/Jira, Wiki, Knowledge repo, NLP text model, MoM generator, email receiver, Transcription/Translation services, etc. will be deployed as scalable docker containers. As described, the AI-enabled bot will utilize these services to perform pre-meeting, in-meeting & post meeting tasks.

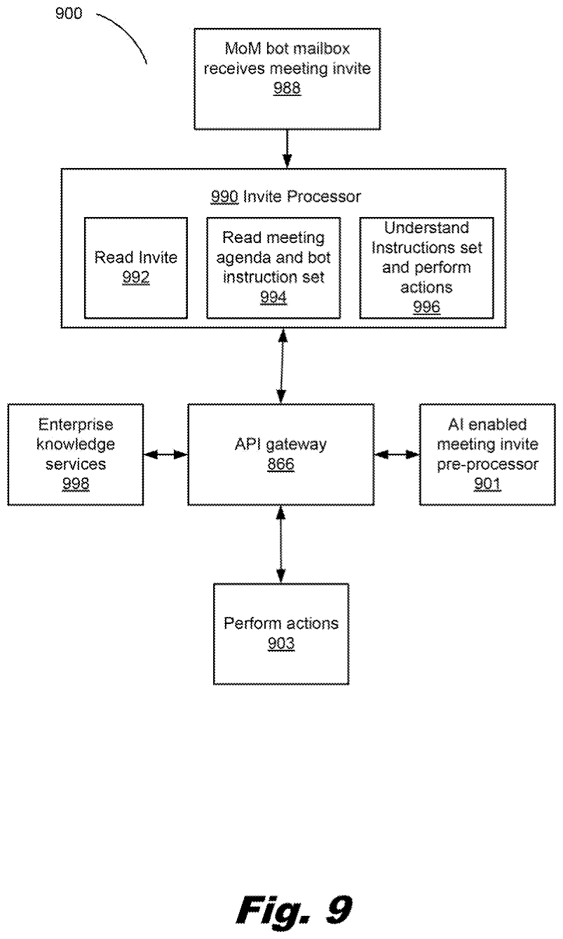

FIG. 9 is a flowchart illustrating an example of a method of electronically supporting a meeting using an automated agent consistent with the disclosed implementations. Specifically, FIG. 9 shows a flowchart of pre-meeting activity by the automated agent. As shown in FIG. 9, the method 900 includes the MoM bot mailbox receiving 988 a meeting invite. The invite is then provided to an invite processor 990 which reads the invite 992 including reading the meeting agenda 994. As described above, the agent may process the email and proceed with meeting support as described herein.

In some examples, rather than relying on NLP or other means, the invite may include a set of instructions specific to the MoM bot. These instructions may be in any format the MoM bot is configured to process. The method 900 will then include reading this instruction set 994 and understanding and performing the actions of the instruction set 996.

Using an API gateway 866, the agent accesses resources and provides information to meeting participants in advance of the meeting. These resources may include enterprise knowledge services such as Jira®, an enterprise wiki, or databases. The API gateway 866 may also be used to access an AI-enabled meeting invite pre-processor 901. The pre-processor may include NLP or other tools for interpreting the meeting invite instructions. The pre-processor may further include accessing an enterprise knowledge repository for information to provide to the meeting participants. The MoM bot may perform pre-meeting actions 903 to prepare meeting participants for the meeting. For example, the MoM bot may send emails, follow-up, pre-fetch wiki details, create new Jira stories, pull feature status, etc. These actions may be performed prior to the meeting to prepare the participants and have the information ready for the meeting.

An example of the pre-meeting flow follows. The organizer creates and sends a meeting invite including an agenda using Microsoft® Outlook or webmail or similar tools with required participants, including the MoM bot. The invite includes Microsoft® team meeting or Zoom® meeting details like meeting URLs, teleconferencing numbers with passcodes to the invite. The organizer may also add the instruction-set containing instructions for the MoM bot. The meeting can be in-person, virtual or hybrid. This portion of the workflow is similar to the existing workflow for the organizer. The organizer additionally adds the MoM bot to the list of recipients and further adds any bot specific instructions to the invite. Otherwise, the process resembles the existing preparation for a meeting for the organizer.

The MoM bot mailbox receives the meeting invite and the instruction-set. The MoM bot will automatically follow-up with meeting participants to getting certain information, for example, Jira/ADO feature details, summary, story, bug, task status, etc.

The MoM bot follows-up with meeting participants for their availability and requests to update relevant Jira/ADO items. The MoM bot automatically shares certain domain specific knowledgebase information with all participants. The identified knowledgebase information may be associated with the meeting topic or agenda. Accordingly, the meeting participants will have ample time to enrich themselves with required knowledge prior to meeting. This preparedness may help to shorten the meeting time. As example, in case of battery swelling, the bot will collect and send all Wiki/RFC/story to the participants for their advance understanding. These kinds of pre-reads may help the meeting participants be prepared with all the information the organization has on the topic of the meeting. Sources of information may include knowledgebases, internal wikis, and databases. As noted above, the meeting participants are another source of pre-read information.

The bot may store the domain specific knowledge links, such as Wiki or RFC, and basic facts in a separate database, e.g., Graph, Elasticsearch, which can be used in-meeting. These facts can be accessed in meeting by querying the bot.

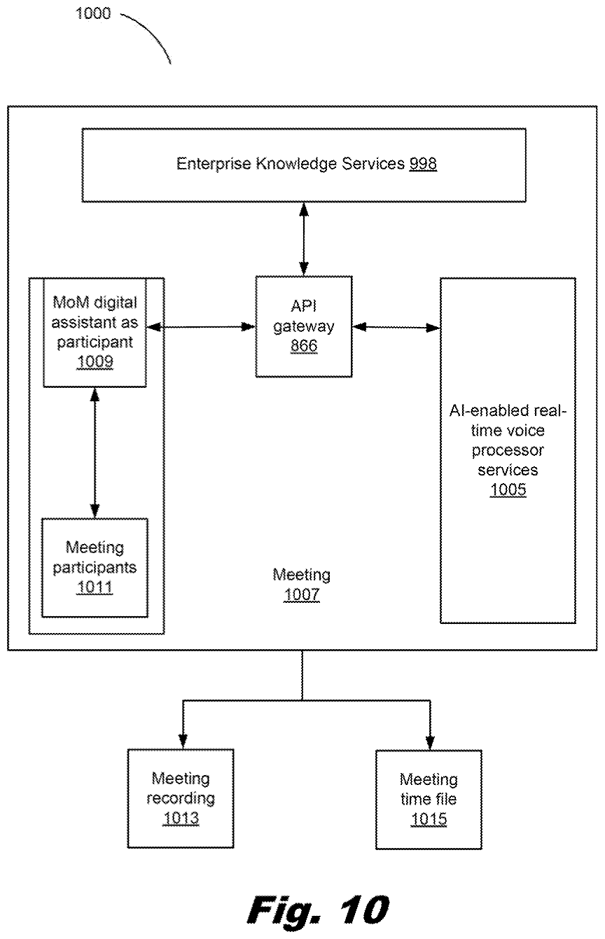

FIG. 10 is a flowchart illustrating an example of a method 1000 of electronically supporting a meeting using an automated agent consistent with the disclosed implementations. FIG. 10 focuses on elements of the in-meeting tasks performed by the agent. As shown in FIG. 10, within the meeting 1007, the meeting participants 1011 and the agent 1009 as another participant confer. The agent uses an API gateway 866 to access enterprise knowledge services 998 and AI-enabled real-time voice processor services 1005. The output includes a meeting recording 1013 and a meeting time file 1015.

When someone is addressed in the meeting, then the next statement/question will be captured and converted to text (using speech to text conversion technology) to understand the statement made or the question asked during meeting. If a question was asked, the agent will retrieve corresponding information from an enterprise knowledgebase like an organization calendar, wiki reference using wiki APIs or from internal database/knowledge repository and connect with ADO/Jira through the API to retrieve feature, story, task details as applicable. The agent can then store the result for further use. Additionally, the agent can provide the result to meeting participants, for example, through a chat window of the conference tool.

e.g. Example of calling wiki API:

### REST API-POST

https://dev.azure.com/fabrikam/_apis/search/wikisearchresults?api-version=6.0-preview.1
API request-{“searchText”:“battery”, “$skip”:0,“$top”:2,“filters”:{“Project”:[“Search”,“Release”]},“$order By”:null,“includeFacets”:true}
e.g. Azure dev-ops (ADO) API

### REST API-POST

https://dev.azure.com/fabrikam/{project}/_apis/wit/workitems/${type}?api-version=6.0
REST API request-[{“op”:“add”,“path”:“/fields/System.Title”,“from”:null,“value”:“develop product API”}]

The agent can detect an active speaker using a software development kit (SDK) available in the conference tool used. The agent can include a call to collect the start time of each active speaker to identify the time slot of each speaker's speech named as time file.

e.g. Sample time file:
{“items”:[{“start_time”:“0.100”,“speaker_label”:“spk_0”,“end_time”:“0.690”}, {“start_time”:“0.690”,“speaker_label”“spk_1”“end_time”:“1.210”}]}

After the meeting has concluded, the agent will convert the voice recorded in “in meeting” to text using a speech-to-text converter. If a participant has been speaking in a different language from a default language, an electronic translator is used by the agent to convert the speech to the default language. To improve processing, the agent may remove from processing those conversations where more than one person is speaking at the same time for more than specific duration.

Using the time file, the agent will associate speakers with converted text. The result will be a transcript of the speaker's speech along with time indicators in a consolidated format.

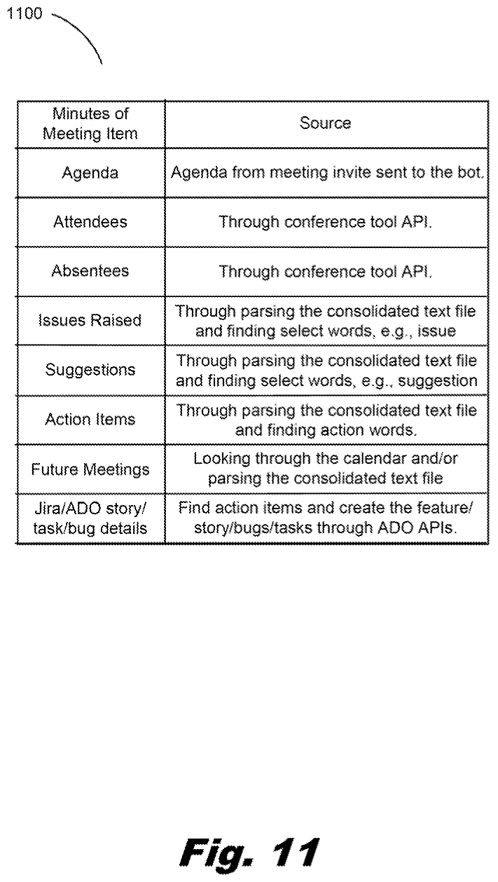

Once the transcript is in the consolidated format, extractive summarization techniques are used for MoM generation. The MoM 1100 can include the details illustrated, for example, in FIG. 11. FIG. 11 is an example of items in minutes of a meeting prepared by the described agent with sources of the items indicated.

The agent will search for specific keywords (such as action verbs, suggestion words, assign to phrases, etc.) to identify issues raised, suggestions or action items and the action owners. For example, the words “problem,” “issue,” “risk,” “bottleneck,” and similar or derivative words can indicate an issued being raised. The words “suggestion,” “proposal,” “advice” and “request” and similar or derivative words can be used to indicate a suggestion made. Words such as, “action,” “plan,” “do,” “do not,” “prepare,” “develop,” “build,” “test,” “deploy,” “implement,” and similar words or derivative words can indicate an action item.

Action items can be paired with spoken names, speaker identification or other data to assign ownership of an action item. For example, sample output text can be analyzed to find the assignee name with the action item matching with assignee name. In a specific example, John is showing as a meeting participant. In sample output text, a sentence states “Let's create the action plan. John, please create new data class and do the predictive modelling and it will be new user story linked to feature 123456” In this case, an action item will be listed and assigned to John as: John: please create new data class and do the predictive modelling and it will be new user story linked to feature 123456. In an example, the meeting minutes consolidate the actions items by assignee so that all the items assigned to a given assignee are listed together. This may aid participants in identifying their action items.

The agent can then create the feature/stories/tasks based on selective keywords using NLP as applicable (ADO action may not be required for all meetings). The resulting record of the meeting, or MoM, can be shared with the meeting organizer for review. After the organizer has reviewed and approved the minutes, an updated record or MoM can be sent to all participants. The minutes may be provided to absent invitees so they can be informed about the information they missed. This may be done by the organizer or by the agent. If the organizer updates the MoM, the update may be sent by organizer the bot to be added to a training set for better training the artificial intelligence or machine learning algorithm of the agent. Specifically, the agent may store this revised MoM in an agent knowledge repository or other database using a corresponding API. In an example, the knowledge repository is a cloud based data repository. Upon receiving an email with a revised or finalized MoM, the agent processor can create Jira/ADO Feature/Stories/Task/Bugs automatically.

Additionally, the agent updates the enterprise information repositories (Jira, wiki, etc.) in addition to drawing information from them. This helps coordinate activity across the company so different teams are up to date. This may be performed after the meeting is over, for example, once the organizer has approved the minutes of the meeting.

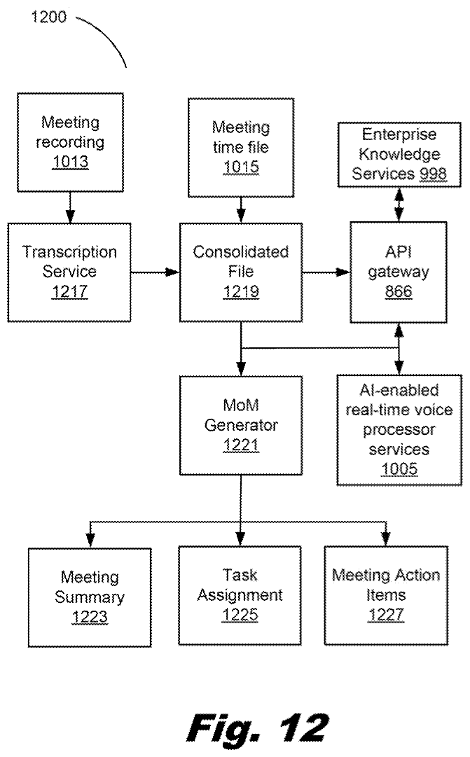

FIG. 12 is a flowchart illustrating an example of a method 1200 of electronically supporting a meeting using an automated agent consistent with the disclosed implementations. As shown in FIG. 12, the meeting recording 1013 is provided to a transcription service 1217. The results are combined with the meeting time file 1015 to provide a consolidated file 1219.

The consolidated file 1219 is output through an API gateway 866 to any of the enterprise knowledge services 998 described herein including to an AI-enabled real-time voice processor service 1005, e.g., a NLP processing service.

The consolidated file and the processing of the consolidated file by the enterprise knowledge services 998, 1005 are provided to a MoM generator 1221 of the agent. The MoM generator 1121 then produces a meeting summary 1223, meeting action items 1127 and task assignment 1225 of those action items.

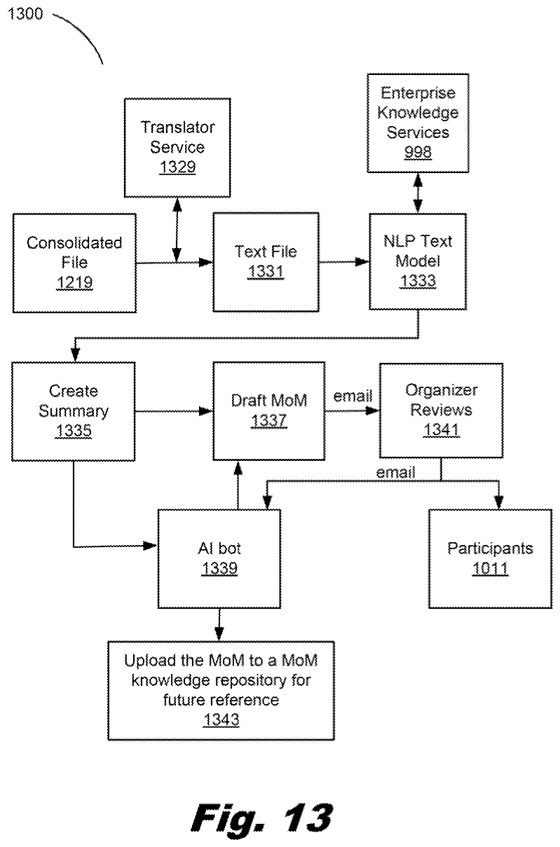

FIG. 13 is a flowchart illustrating an example of a method 1300 of electronically supporting a meeting using an automated agent consistent with the disclosed implementations. As shown in FIG. 13, a consolidated file 1219 is processed by a translator/transcription service 1329 to provide a text file 1331.

The transcription service may use deep learning automatic speech recognition (ASR) to convert speech to text quickly and accurately. With custom vocabulary lists, new words can be added to the base vocabulary to generate more accurate transcriptions with a domain-specific word corpus, part-of-speech, technical terminologies etc. Also, the transcription service could be configured to mask or remove words per a list of words or keywords to mask or reject. In an example, the agent asks for verification of new domain-specific words identified.

The video conferencing tool will be aware of which participant is speaking at a given time and may highlight that speaker in the on-screen meeting display to help other participants identify who is speaking. Consequently, the consolidated file may also include a time file that indicates which speaker identified by the video conferencing tool, using for example login or screen name, was speaking at each segment of time. This may include a start time of each speaker that can be correlated to the text from the transcription service to accurately tag speech segments to the meeting participant who was speaking at the time.

The text file 1331 is input to a Natural Language Processing model 1333. This model may use any of the enterprise knowledge services 998 described herein. The result is used to create a summary 1335 of the meeting.

The NLP model 1331 may include extractive summarization. Extractive summarization can be defined as a task of producing a concise and fluent summary while preserving key information and overall meaning. Extractive summarization may comprise three independent tasks. (1) Intermediate representation of input text which includes topic representation (with the help of TFIDF Score/Latent Semantic Analysis/Bayesian Topic Model/etc.) and indicator representation (with the help of PageRank Algorithms/ . . . ); (2) Scoring the sentence based on representation and (3) Summary creation based on a specified number of sentences.

Purely extractive summaries may give better results compared to automatic abstractive summaries. This is because abstractive summarization methods cope with problems such as semantic representation, inference and natural language generation which is relatively harder than data-driven approaches such as sentence extraction with extractive summarization.

High level steps involved in Text Summarization and MoM generation include:
1. Input consolidated file
2. remove stop words and clean document
3. split the sentences in text and build a document term matrix
4. Score/Rank the sentences
5. Based on keywords, NLP engine will interact with ADO/Jira/Wiki to extract the relevant information through corresponding APIs.
6. Summary/MoM creation based on sentences and information collected from ADO/Jira/Wiki.

This summary is provided to an AI-enabled bot 1339. The bot 1339 will process the summary as described herein to produce minutes of a meeting. The summary 1335 may be combined with the output of the bot 1339 to produce a draft MoM 1337.

The draft MoM 1337 is then delivered, for example by email, to the meeting organizer 1341 for review. As noted above, after review and possible correction, the organizer 1341 may transmit, e.g. by email, the revised MoM to the meeting participants 1011 and to the bot 1339. The bot 1339 will add the final MoM to a knowledge repository for future reference, e.g., for training the AI features of the bot.

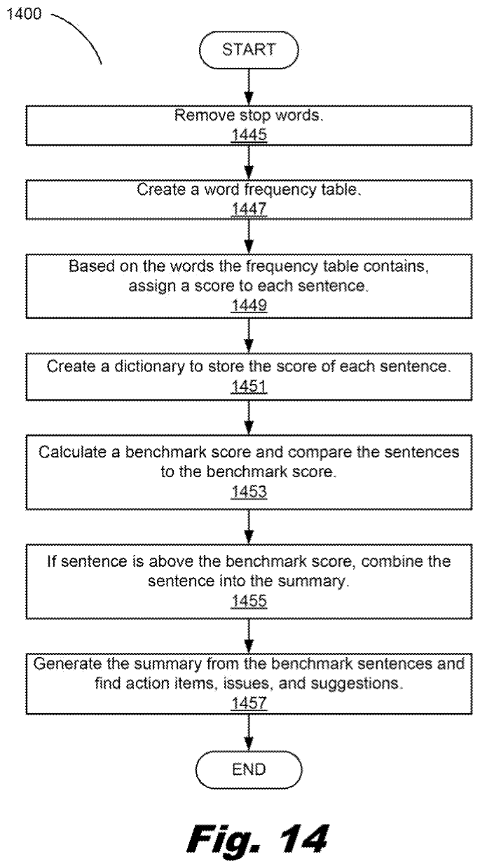

FIG. 14 is a flowchart illustrating an example of a method of electronically supporting a meeting using an automated agent consistent with the disclosed implementations. FIG. 14 illustrates more details on the generation of the meeting summary 1335 of FIG. 13.

As shown in FIG. 14, generating the summary 1335 may include: removing stop words 1445, such as an, the, etc.; creating a word frequency table 1447; based on the words the frequency table contains, assign a score to each sentence 1449, create a dictionary to store the score of each sentence 1451; calculate a benchmark score, for example, an average of all the scores; and compare the sentences to the benchmark score 1453. If a sentence has a score above a benchmark score, combine 1455 the sentence into the summary. Then, the summary is generated 1457 using the benchmark sentences which have a score above the benchmark score and the summary is tokenized to find action items, issues, and suggestions. In some examples, the benchmark score is based on an average score. The benchmark score may be an average score divided by a length of the sentence. For example, the benchmark score may be 120% of the average score divided by the length of the sentence. The summary is then tokenized and checked for words indicating problems, suggestions, and action items.

In a specific example, the input from the meeting recording may be:

a. Let's start discussing the battery problem. Recently, we are seeing battery problems and customer complaints about battery swelling. Can we work on this problem asap? Any thoughts how to solve this problem.

b. Yes, we need to predict battery swelling correctly to solve this problem. There are many techniques to predict the battery swelling problem, but we need to analyze the data completely.

c. We have lots of data regarding battery issues. But, the data are stored in different places. The problem is we have so many classes but no two classes are connected with a primary key, hence the data are disjointed in nature.

d. Here's a suggestion—We need to create a new class which is connected with other classes and then we can easily merge all the data, so we can make accurate predictions to solve this problem.

e. Let's create the action plan, John please create the new data class and do the predictive modelling and it will be new user story linked to feature 123456.

The text summarization is as follows: “There are many techniques to predict the battery swelling problem, but we need to analyze the data completely. Here's a suggestion—We need to create a new class which is connected with other classes and then we can easily merge all the data, so we can make accurate predictions to solve this problem.”

Problem Statement is: [The problem is we have so many classes but no two classes are connected with a primary key, hence the data are disjointed in nature.’]

The Suggestion is as follows: [Here's a suggestion—We need to create a new class which is connected with other classes and then we can easily merge all the data, so we can make accurate predictions to solve this problem.]

The Action item is as follows: [“Let's create the action plan, John please create the new data class and do the predictive modelling and it will be new user story linked to feature 123456.”]

Illustrative code for this is as follows.

```
#!/usr/bin/env python
# coding: utf-8
# In[77]:
file1 = open(″C:\\Sample_Input.txt″,″r+″)
txt = file1.read( )
print(txt)
file1.close( )
# In[78]:
import nltk
from nltk.corpus import stopwords
from nltk.tokenize import word_tokenize, sent_tokenize
# Input text (to summarize)
text = txt
# Tokenizing the text
stopWords = set(stopwords.words(″english″))
words = word_tokenize(text)
# Creating a frequency table to keep the score of each word
freqTable = dict( )
for word in words:
  word = word.lower( )
  if word in stopWords:
    continue
  if word in freqTable:
    freqTable[word] += 1
  else:
    freqTable[word] = 1
#
# Creating a dictionary to keep the score of each sentence
sentences = sent_tokenize(text)
sentenceValue = dict( )
for sentence in sentences:
  for word, freq in freqTable.items( ):
    if word in sentence.lower( ):
      if sentence in sentenceValue:
        sentenceValue[sentence] += freq
      else:
        sentenceValue[sentence] = freq
sumValues = 0
for sentence in sentenceValue:
  sumValues += sentenceValue[sentence]
# Average value of a sentence from the original text
  average = int(sumValues / len(sentenceValue))
# Storing sentences into our summary.
summary = ″
for sentence in sentences:
  if (sentence in sentenceValue) and (sentenceValue[sentence] > (1.2 *
average)):
    summary += ″ ″ + sentence
print(summary)
# In[79]:
print(summary)
# In[80]:
from nltk.tokenize import word_tokenize, sent_tokenize
list1 = [″Problem″]
text = txt
sentences_with_word1 = [ ]
for sen in sent_tokenize(text):
  I = word_tokenize(sen)
  if len(set(I).intersection(list1))>0:
    sentences_with_word1.append(sen)
# In[81]:
print(sentences_with_word1)
# In[82]:
from nltk.tokenize import word_tokenize, sent_tokenize
list1 = [″suggestion″]
text = txt
sentences_with_word2 = [ ]
for sen in sent_tokenize(text):
  I = word_tokenize(sen)
  if len(set(I).intersection(list1))>0:
    sentences_with_word2.append(sen)
# In[83]:
print(sentences_with_word2)
# In[84]:
from nltk.tokenize import word_tokenize, sent_tokenize
list1 = [″action″]
text = txt
sentences_with_word3 = [ ]
for sen in sent_tokenize(text):
  I = word_tokenize(sen)
  if len(set(I).intersection(list1))>0:
    sentences_with_word3.append(sen)
# In[85]:
print(sentences_with_word3)
# In[93]:
file2 = open(″C:\\Sample_Output.txt″,″a″)
print (″Writing Summary in Output file″)
txt= file2.write(″\n The Text Summarization is:\n″)
txt=file2.write(summary)
print(txt)
file2.close( )
# In[94]:
file2 = open(″C:\\Sample_Output.txt″,″a″)
txt = file2.write(″\n The Problem Statement is: \n″)
txt=file2.write(str(sentences_with_word1))
print(txt)
file2.close( )
# In[95]:
file2 = open(″C:\\Sample_Output.txt″,″a″)
txt = file2.write(″\n The Suggestion(s) are:\n″)
txt=file2.write(str(sentences_with_word2))
print(txt)
file2.close( )
# In[96]:
file2 = open(″C:\\Sample_Output.txt″,″a″)
txt = file2.write(″\n The Action item(s) are:/n ″)
txt=file2.write(str(sentences_with_word3))
print(txt)
file2.close( )
```

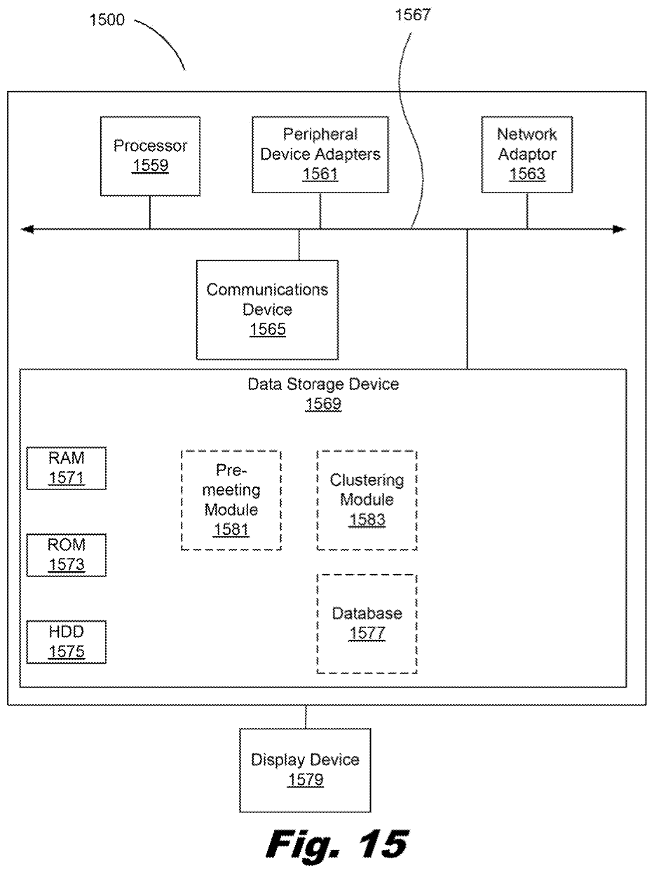

FIG. 15 is a diagram of a computing device 1500 for supporting a meeting, consistent with the disclosed implementations. The computing device 1500 may be implemented in an electronic device. Examples of electronic devices include servers, desktop computers, laptop computers, personal digital assistants (PDAs), mobile devices, smartphones, gaming systems, and tablets, among other electronic devices.

The computing device 1500 may be utilized in any data processing scenario including, stand-alone hardware, mobile applications, through a computing network, or combinations thereof. Further, the computing device 1500 may be used in a computing network. In an example, the methods provided by the computing device 1500 are provided as a service over a network by, for example, a third party.

To achieve its desired functionality, the computing device 1200 includes various hardware components. Among these hardware components may be a number of processors 1559, a number of data storage devices 1569, a number of peripheral device adapters 1561, and a number of network adapters 1563. These hardware components may be interconnected through the use of a number of busses and/or network connections. In an example, the processor 1559, data storage device 1569, peripheral device adapters 1561, and a network adapter 1563 may be communicatively coupled via a bus 1567.

The processor 1559 may include the hardware architecture to retrieve executable code from the data storage device 1569 and execute the executable code. The executable code may, when executed by the processor 1559, cause the processor 1559 to obtain information for a meeting prior to the meeting, provide the information to the participants in advance of the meeting, virtually attend the meeting, record the meeting, or prepare minutes of the meeting. The processor may further answer questions during the meeting using the information gathered prior to the meeting. The functionality of the computing device 1500 is in accordance to the methods of the present specification described herein. In the course of executing code, the processor 1559 may receive input from and provide output to a number of the remaining hardware units.

The data storage device 1569 may store data such as executable program code that is executed by the processor 1559 and/or other processing device. The data storage device 1569 may specifically store computer code representing a number of applications that the processor 1559 executes to implement at least the functionality described herein.

The data storage device 1569 may include various types of memory modules, including volatile and nonvolatile memory. For example, the data storage device 1569 of the present example includes Random Access Memory (RAM) 1571, Read Only Memory (ROM) 1573, and Hard Disk Drive (HDD) memory 1575. Other types of memory may also be utilized, and the present specification contemplates the use of many varying type(s) of memory in the data storage device 1569 as may suit a particular application of the principles described herein. In certain examples, different types of memory in the data storage device 1569 may be used for different data storage needs. For example, in certain examples the processor 1559 may boot from Read Only Memory (ROM) 1571, maintain nonvolatile storage in the Hard Disk Drive (HDD) memory 1575, and execute program code stored in Random Access Memory (RAM) 1573.

The data storage device 1569 may include a computer readable medium, a computer readable storage medium, or a non-transitory computer readable medium, among others. For example, the data storage device 1569 may be, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The data storage device 1569 may include a database 1577. The database 1577 may include information for the meeting, for example, information from the company's knowledgebase(s) acquired prior to the meeting.

Hardware adapters, including peripheral device adapters 1561 in the computing device 1500 enable the processor 1559 to interface with various other hardware elements, external and internal to the computing device 1500. For example, the peripheral device adapters 1561 may provide an interface to input/output devices, such as, for example, display device 1579. The peripheral device adapters 1561 may also provide access to other external devices such as an external storage device, a number of network devices such as, for example, servers, switches, and routers, client devices, other types of computing devices, and combinations thereof.

The display device 1579 may be provided to allow a user of the computing device 1500 to interact with and implement the functionality of the computing device 1500. The peripheral device adapters 1561 may also create an interface between the processor 1559 and the display device 1579, a printer, and/or other media output devices. The network adapter 1563 may provide an interface to other computing devices within, for example, a network, thereby enabling the transmission of data between the computing device 1500 and other devices located within the network.

The computing device 1500 may, when executed by the processor 1559, display the number of graphical user interfaces (GUIs) on the display device 1579 associated with the executable program code representing the number of applications stored on the data storage device 1569. The GUIs may display, for example, interactive screenshots that allow a user to interact with the computing device 1500. Examples of display devices 1579 include a computer screen, a laptop screen, a mobile device screen, a personal digital assistant (PDA) screen, and a tablet screen, among other display devices 1579.

In an example, the database 1577 stores information obtained by the agent prior to the meeting. The database 1577 may include the information obtained from a company's knowledgebase. The database 1577 may include information obtained from meeting participants in advance of the meeting.

The computing device 1500 further includes a number of modules 1581, 1583 used in the implementation of the systems and methods described herein. The various modules 1581, 1583 within the computing device 1500 include executable program code that may be executed separately. In this example, the various modules 1581, 1583 may be stored as separate computer program products. In another example, the various modules 1581, 1583 within the computing device 1500 may be combined within a number of computer program products; each computer program product including a number of the modules 1581, 1583. Examples of such modules include a Natural Language Processor (NLP) module 1581 and a Question-and-Answer module 1583.

In FIG. 15, the dashed boxes indicate instructions 1581, 1583 and a database 1577 stored in the data storage device 1569. The solid boxes in the data storage device 1569 indicate examples of different types of devices which may be used to perform the data storage device 1569 functions. For example, the data storage device 1569 may include any combination of RAM 1571, ROM 1573, HDD 1575, and/or other appropriate data storage medium, with the exception of a transient signal as discussed above.

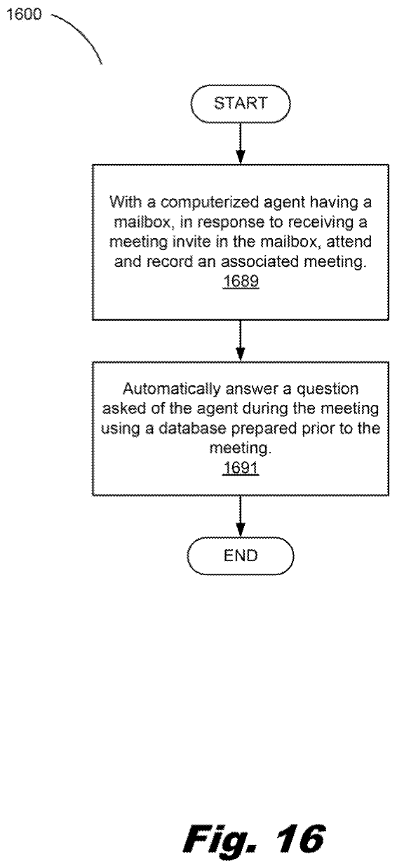

FIG. 16 is a flowchart illustrating an example of a method 1600 of electronically supporting a meeting using an automated agent consistent with the disclosed implementations. The method 1600 includes with a computerized agent having a mailbox, in response to receiving a meeting invite in the mailbox, attend 1689 and record an associated meeting. The method 1600 also includes with the agent, automatically answer 1691 a question asked of the agent during the meeting using a database prepared prior to the meeting.

The method 1600 includes with a computerized agent having a mailbox, in response to receiving a meeting invite in the mailbox, attend 1689 and record an associated meeting. The computerized agent may function through the standard email invite provided with meeting information. In an example, the computerized agent recognizes meeting invite information, including time and log in information for the meeting. The computerized agent records the meeting so that a summary can be generated after the meeting. The computerized agent also tracks the speaker and notes the times when new speakers start speaking. This allows the transcript to include the speaker information.

The method 1600 also includes with the agent, automatically answer 1691 a question asked of the agent during the meeting using a database prepared prior to the meeting. The agent may use the Question-and-Answer module to answer questions. In some examples, the agent converts the question to text and then searches based on the text. The answer is then provided audibly in the meeting to the questioner. This allows meeting participants to access the database of information gathered prior to the meeting by the agent. The agent may monitor the conversation of the meeting and volunteer relevant information from the database. Alternately, the agent may speak only when questioned by a meeting participant. For example, the agent may respond only when its name is used to preface a question.

In conclusion, the AI-enabled MoM agent described herein can save time for each meeting through automating pre-meeting, in-meeting and post-meeting tasks. The overall time and effort saving across organization can be significant. Because each meeting and a record thereof is digitized, the meetings would be more productive. Action-items, tasks, and assignments can be tracked easily and automatically. If manual documentation is used, a majority of meetings may go undocumented. The described agent will automate most all of MoM creation tasks. Specifically, the agent will (1) automate pre-meeting tasks like follow up tasks' status with participants, Jira/ADO feature tracking, check availability of meeting participants, fetch and share certain details with participants; (2) Automate in-meeting tasks like real-time question answers; and (3) automate post meeting tasks like MoM creation with attendees, meeting summary, action items, tasks, assignments, suggestions etc.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method of electronically supporting a meeting, the method comprising:
with a computerized agent having a mailbox, receiving a meeting invite from a meeting organizer, the meeting invite including meeting participants, meeting attendance information and a meeting agenda; and
with the agent, in response to receiving the meeting invite, automatically communicating with the meeting participants in advance of the meeting to prepare for the meeting.

2. The method of claim 1, further comprising, with the agent, in advance of the meeting, communicating electronically with meeting participants to request information relevant to the meeting agenda.

3. The method of claim 1, further comprising, with the agent, in advance of the meeting, transmitting to the meeting participants background information for items on the meeting agenda.

4. The method of claim 1, further comprising deploying the computerized agent as a docker containerized service.

5. The method of claim 1, further comprising, with the agent, recording audio of the meeting and processing the audio of the meeting to produce a record of the meeting.

6. The method of claim 5, further comprising, with the agent, using speech-to-text conversion on the recorded audio of the meeting and Natural Language Processing to produce a meeting summary and wherein the meeting summary comprises:
issues raised;
suggestions made; and
action items assigned.

7. The method of claim 5, further comprising, with the agent, audibly answering, in the meeting, a question asked of the agent by a meeting participant.

8. The method of claim 5, further comprising:
with the agent, preparing an attendance record of the meeting based on participant login and voice recognition; and
with the agent, providing the attendance record to the meeting organizer.

9. A computerized agent comprising:
a bot for supporting a meeting using artificial intelligence to process an electronic recording of the meeting to extract information about the meeting for a meeting organizer or participant;
wherein the bot is deployed as a docker containerized service.

10. The computerized agent of claim 9, further comprising Kubernetes as a container orchestration engine for the docker containerized service of the bot.

11. The computerized agent of claim 9, wherein an electronic conference client is bundled with a container image of the bot.

12. The computerized agent of claim 9, further comprising a bot scheduler deployed as a container, the bot scheduler to initialize a separate container for each meeting.

13. The computerized agent of claim 9, further comprising an inbox in which to receive a meeting invite with information for a meeting, including meeting participants, the bot to respond to receipt of the meeting invite by automatically communicating with the meeting participants in advance of the meeting to prepare for the meeting.

14. A non-transitory computer-readable medium comprising a computerized agent for supporting a planned meeting, the agent comprising:
instructions for receiving meeting information about the planned meeting, including meeting participants and a meeting agenda; and
instructions for, in response to receiving the meeting information, communicating electronically with the meeting participants to request information related to the meeting agenda.

15. The computer-readable medium of claim 14, further comprising instructions for:
identifying information in a knowledgebase that is related to the meeting agenda; and
transmiting the identified information to the meeting participants in advance of the meeting.
